(19) United States
(12) Patent Application Publication
(10) Pub. No.: US 2007/0040397 A1
(43) Pub. Date: Feb. 22, 2007

(54) Secure adjustable strike plate

(76) Inventors: Marvin R. Nicholas JR., Dallas County, TX (US); David L. Stevens, Tarrant County, TX (US)

Correspondence Address: W. THOMAS TIMMONS, 1320 PRUDENTIAL DRIVE, SUITE 208, DALLAS, TX, 75235-4117, US

(21) Appl. No.: 11/206,349

(22) Filed: Aug. 18, 2005

(51) Int. Cl. E05B 15/02

(52) U.S. Cl. 292/341.18

(57) ABSTRACT

A strike plate assembly for mounting on a door frame is disclosed. The door frame forms a clearance hole for receiving the strike plate assembly. A mounting plate is affixed to the door frame in the clearance hole. The mounting plate forms an opening for receiving a bolt from a door knob or lock, such as a dead bolt lock, and forms two substantially parallel slots. A strike plate is affixed to the mounting plate. The strike plate also forms an opening for receiving a bolt from a door knob or lock and forms two substantially parallel slots which are at right angles to the two substantially parallel slots of the mounting plate. Each of the parallel slots of strike plate crosses over a corresponding one of the parallel slots of the mounting plate when the strike plate is properly affixed to the mounting plate. A pair of nuts and bolts affix the strike plate to the mounting plate. One bolt fits through each of the parallel slots of the strike plate and the corresponding parallel slot of the mounting plate. The pair of nuts secure the pair of bolts such that the position of the bolts can be adjusted in the parallel slots of the mounting plate and in the parallel slots of the strike plate, allowing the strike plate to be adjusted both vertically and horizontally with respect to the mounting plate. The opening formed by the strike plate substantially overlaps the opening formed by the mounting plate, although the opening formed by the mounting plate would normally be substantially larger than the opening formed by the strike plate.

### CROSS-REFERENCE TO RELATED APPLICATIONS

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to strike plates for latch bolts, dead bolts and other bolts associated with door knobs and locks, and in one of its aspects to strike plates and strike plate assemblies which can be adjusted to match the position of the bolt or bolts when the door is closed.

2. Description of Related Art

Conventional door hardware includes a door knob or lock, with a bolt and a cooperating strike mounted on the door jamb to receive the bolt. In the most common arrangement, the strike plate is a simple stamped metal plate which forms an opening of suitable size and shape to receive the bolt with some clearance. In a typical arrangement, the strike is mounted to the door jamb using wood screws that are fixed to the door jamb.

For the door and the door jamb to work properly, the lock or deadbolt must fit perfectly into the opening of the door strike. If either the strike or the lock are out of position and do not mate correctly, the door will not close properly creating a serious security risk. The problem with accurately positioning the lock and strike is twofold: First, there is the problem involved in the original mounting of the lock and the strike. Typically, the lock is mounted in the door first and then the strike is located in the door jamb so that it matches identically to the lock. The second problem arises when a building settles or changes relative position as a consequence of age or other factors. In those circumstances, it is typical that a door and door jamb will become out of alignment with one another so that the lock does not mate properly with the strike. This creates a serious problem not only with regard to security and the aesthetic look of the door; but, as one attempts to reposition the strike by reboring holes into the door jamb, it weakens the structure of the door jamb and creates additional security and aesthetic problems. Therefore, a need has been recognized in the art for a strike that is adjustable without reboring the door jamb.

The foregoing problems have been recognized in the art for many years and a number of solutions have been proposed. U.S. Pat. No. 4,892,341 to Dietrich for a Self-adjusting Door Strike describes a device that uses a compensating member spanning the strike opening. The compensating member is comprised of a resilient spring loaded member and compensates for the relative position of the latch/deadbolt and door jamb by a biasing member. The disadvantages of this device is that it is complicated to manufacture and assemble and requires spring loaded parts which are subject to fatigue and therefore, pose serious security risks. It does not permit mounting both a latch and a deadbolt.

U.S. Pat. No. 5,171,050 to Mascotte for Adjustable Strike for Door-Locking and Door-Latching Mechanisms is for use with a tubular door frame.

U.S. Pat. No. 5,118,151 to Nicholas, Jr. et al. for Adjustable Door Strike and Mounting Template allows for vertical adjustment of the strike plate.

U.S. Pat. No. 4,492,397 to Allenbaugh for an Adjustable Strike describes a door strike that is primarily adjustable in the horizontal position. It provides for a\ vertical adjustment only by the use of oversized mounting holes. Thus, the strike has both its aperture and mounting means in one piece. A significant disadvantage of the Allenbaugh device is that the vertical adjustment is minor and requires the reboring of the mounting socket in the door jamb. A second problem with the Allenbaugh device is that it is not suitable for mounting both a latch and a deadbolt without reboring the door jamb.

U.S. Pat. No. 3,506,293 to Russell et al. for Adjustable Strike describes a strike with two plates: an outer and inner plate. The inner plate is fastened to the door jamb and the outer plate then is mounted over it and provides for adjustment in the horizontal direction only. No vertical adjustment is provided without reboring the door jamb.

U.S. Pat. No. 3,416,829 to Russell et al. for Adjustable Strike provides for an adjustment in the horizontal direction but no adjustment in the vertical position. In order to adjust the vertical position, the Russell device requires reboring the doorjamb and reassembling the device. As mentioned before, this is both aesthetically displeasing and poses a security risk.

U.S. Pat. No. 3,257,139 to Russell et al. for Adjustable Strike describes a door strike that is adjustable only in the horizontal direction by use of elongated mounting apertures. No vertical adjustment is contemplated without reboring the door jamb.

U.S. Pat. No. 2,990,211 to Wartain for Adjustable Strike Plate describes another strike that is adjustable only in the horizontal direction using elongated mounting holes. Wartain's device cannot be vertically adjusted without reboring the door jamb.

U.S. Pat. No. 2,781,219 to Bahorik for Adjustable Strike Plate offers a variation to the elongated hole approach by providing two embodiments. In one embodiment, there is provided an elongated notched aperture that permits adjustment of the strike in the horizontal direction only. In a second embodiment, the strike plate assembly includes rows and columns of apertures that mate with the securing plates. The primary purpose is to permit adjustment in the horizontal direction with some vertical adjustment based upon the size of the opening in the elongated mounting holes. The Bahorik device does not provide for the universal mounting of either a latch or a deadbolt and is severely limited with respect to vertical adjustment in that it is not continuously adjustable.

U.S. Pat. No. 2,094,119 to Flora for Adjustable Lock Strike shows a spring loaded system that provides both lateral and longitudinal alignment of the strike plate. The disadvantage is that the springs will fatigue over time and it provides only limited vertical and lateral adjustment. A further disadvantage of the Flora device is that it requires that both the latch and deadbolt strikes be included in a single part.

U.S. Pat. No. 1,733,412 to Karns for Adjustable Striker Plate discloses an adjustable striker that is adjustable only in the horizontal direction and therefore has the disadvantage that it cannot be adjusted vertically without reboring the door jamb creating both the aesthetic and security problems that have been previously mentioned.

### BRIEF SUMMARY OF THE INVENTION

A strike plate assembly according to the present invention, is for mounting on a door frame. The door frame forms a clearance hole for receiving the strike plate assembly. A mounting plate is affixed to the door frame in the clearance hole. The mounting plate forms an opening for receiving a bolt from a door knob or lock, such as a dead bolt lock, and forms two substantially parallel slots. A strike plate is affixed to the mounting plate. The strike plate also forms an opening for receiving a bolt from a door knob or lock and forms two substantially parallel slots which are at right angles to the two substantially parallel slots of the mounting plate. Each of the parallel slots of strike plate crosses over a corresponding one of the parallel slots of the mounting plate when the strike plate is properly affixed to the mounting plate. A pair of nuts and bolts affix the strike plate to the mounting plate. One bolt fits through each of the parallel slots of the strike plate and the corresponding parallel slot of the mounting plate. The pair of nuts secure the pair of bolts such that the position of the bolts can be adjusted in the parallel slots of the mounting plate and in the parallel slots of the strike plate, allowing the strike plate to be adjusted both vertically and horizontally with respect to the mounting plate.

The opening formed by the strike plate substantially overlaps the opening formed by the mounting plate, although the opening formed by the mounting plate would normally be substantially larger than the opening formed by the strike plate.

In one arrangement of a strike plate assembly according to the present invention, the mounting plate forms a second opening for receiving a bolt from a door knob or lock vertically separated from the first opening, and the strike plate forms a second opening for receiving a bolt from a door knob or lock vertically separated from the first opening. The first opening formed by the strike plate substantially overlaps the first opening formed by the mounting plate and the second opening formed by the strike plate substantially overlaps the second opening formed by the mounting plate.

In another arrangement, a strike plate assembly for mounting on a door frame, includes a mounting plate for affixing to the door frame in the clearance hole which forms a first opening and a second opening for receiving bolts from a door knob or lock and forms two substantially parallel slots associate with each opening. A first strike plate is affixed to the mounting plate and forms an opening for receiving a bolt from a door knob or lock and forms two substantially parallel slots which are at right angles to the two substantially parallel slots of the mounting plate. Each of the parallel slots of strike plate crosses over a corresponding one of the parallel slots of the mounting plate when the first strike plate is properly affixed to the mounting plate. A pair of bolts, one bolt for fitting through each of the parallel slots of the first strike plate and the corresponding parallel slot of the mounting plate and a pair of nuts for securing the pair of bolts. A second strike plate, vertically separated from the first strike plate, forms an opening for receiving a bolt from a door knob or lock. The opening formed by the first strike plate substantially overlaps the first opening formed by the mounting plate and the opening formed by the second strike plate substantially overlaps the second opening formed by the mounting plate.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a front elevational view of a strike plate assembly according to the present invention;

FIG. 2 is a rear elevational view of the strike plate assembly of FIG. 1;

FIG. 3 is a sectional view of the strike plate assembly of FIG. 1 taken along the lines 3-3 of FIG. 2;

FIG. 4 is a sectional view of the strike plate assembly of FIG. 1 taken along the lines 4-4 of FIG. 2; and

FIG. 5 is a rear elevational view of an alternative embodiment of a strike plate assembly according to the present invention.

### DETAILED DESCRIPTION OF THE INVENTION

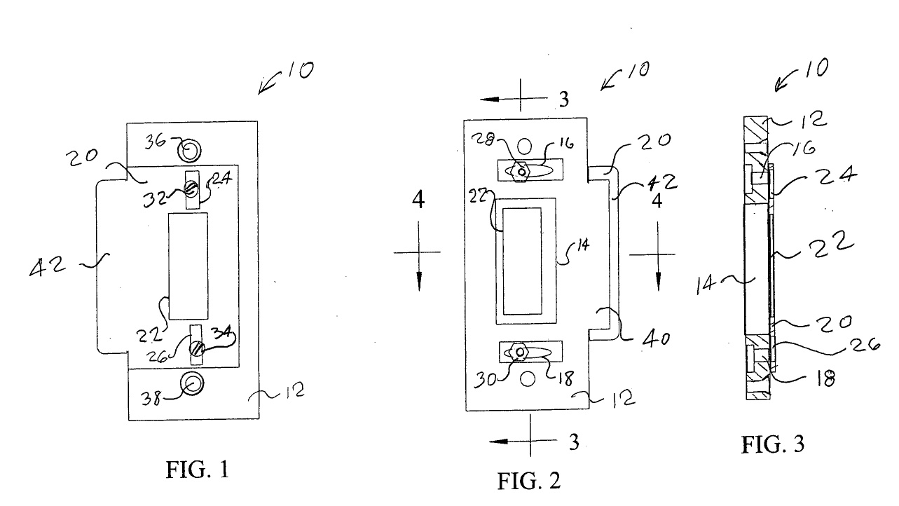

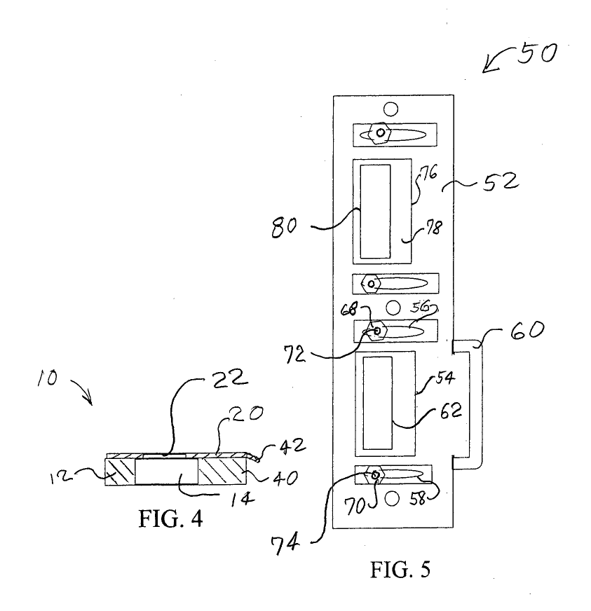

Referring now to the drawing, and in particular to FIGS. 1-4, a strike plate assembly according to the present invention is referred to generally by reference numeral 10. Strike plate assembly 10 is for mounting on a door frame, not shown. The door frame forms a clearance hole for receiving the strike plate assembly. A mounting plate 12 is affixed to the door frame in the clearance hole. Mounting plate 12 forms an opening 14 for receiving a bolt from a door knob or lock, such as a dead bolt lock. Mounting plate 12 also forms two substantially parallel slots, first horizontal slot 16 and second horizontal slot 18. A strike plate 20 is affixed to the mounting plate. Strike plate 20 also forms an opening 22 for receiving a bolt from a door knob or lock and forms two substantially parallel slots, first vertical slot 24 and second vertical slot 26. The substantially parallel slots in strike plate 20 are at right angles to the two substantially parallel slots of mounting plate 12. Each of the parallel slots of strike plate 20 crosses over a corresponding one of the parallel slots of mounting plate 12 when the strike plate is properly affixed to the mounting plate. A pair of nuts 28 and 30 and bolts 32 and 34 affix the strike plate to the mounting plate. One bolt fits through each of the parallel slots of the strike plate and the corresponding parallel slot of the mounting plate. The pair of nuts secure the pair of bolts such that the position of the bolts can be adjusted in the parallel slots of the mounting plate and in the parallel slots of the strike plate, allowing the strike plate to be adjusted both vertically and horizontally with respect to the mounting plate.

Opening 22 formed by strike plate 20 substantially overlaps opening 14 formed by mounting plate 12, although the opening formed by the mounting plate would normally be substantially larger than the opening formed by the strike plate.

Mounting plate 12 is affixed to the door frame by screws inserted through countersunk holes 36 and 38. Mounting plate 12 also forms a flat tongue 40 which gives additional structural support to curved tongue 42 formed by strike plate 20.

Referring also to FIG. 5, an alternative embodiment of a strike plate assembly according to the present invention is referred to generally by reference numeral 50. A mounting plate 52 forms is affixed to the door frame in the clearance hole. Mounting plate 52 forms a first opening 54 for receiving a bolt from a door knob or lock, such as a dead bolt lock. Mounting plate 52 also forms a first two substantially parallel slots, first horizontal slot 56 and second horizontal slot 58. A first strike plate 60 is affixed to the mounting plate. First strike plate 60 also forms an opening 62 for receiving a bolt from a door knob or lock and forms two substantially parallel slots, a first vertical slot and second vertical slot, not shown. The substantially parallel slots in strike plate 60 are at right angles to the two substantially parallel slots of mounting plate 52. Each of the parallel slots of strike plate 60 crosses over a corresponding one of the parallel slots of mounting plate 52 when the strike plate is properly affixed to the mounting plate. A pair of nuts 68 and 70 and bolts 72 and 74 affix the first strike plate to the mounting plate. One bolt fits through each of the parallel slots of the strike plate and the corresponding parallel slot of the mounting plate. The pair of nuts secure the pair of bolts such that the position of the bolts can be adjusted in the parallel slots of the mounting plate and in the parallel slots of the strike plate, allowing the strike plate to be adjusted both vertically and horizontally with respect to the mounting plate.

Mounting plate 52 also forms a second opening 76 for receiving a bolt from a door knob or lock vertically separated from first opening 54, and a second strike plate 78 forms a second opening 80 for receiving a bolt from a door knob or lock vertically separated from the first opening. The opening formed by first strike plate 60 substantially overlaps the first opening formed by mounting plate 52 and opening 80 formed by second strike plate 78 substantially overlaps second opening 76 formed by the mounting plate.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A strike plate assembly for mounting on a door frame, wherein the door frame forms a clearance hole for receiving the strike plate assembly, comprising in combination:
a mounting plate for affixing to the door frame in the clearance hole, wherein the mounting plate forms an opening for receiving a bolt from a door knob or lock and forms two substantially parallel slots;
a strike plate for affixing to the mounting plate, forming an opening for receiving a bolt from a door knob or lock and forming two substantially parallel slots which are at right angles to the two substantially parallel slots of the mounting plate, wherein each of the parallel slots of strike plate crosses over a corresponding one of the parallel slots of the mounting plate when the strike plate is properly affixed to the mounting plate;
a pair of bolts, one bolt for fitting through each of the parallel slots of the strike plate and the corresponding parallel slot of the mounting plate; and
a pair of nuts for securing the pair of bolts, thereby affixing the strike plate to the mounting plate, wherein the position of the bolts can be adjusted in the parallel slots of the mounting plate and in the parallel slots of the strike plate, whereby the strike plate can be adjusted both vertically and horizontally with respect to the mounting plate.

2. A strike plate assembly according to claim 1 wherein the opening formed by the strike plate substantially overlaps the opening formed by the mounting plate.

3. A strike plate assembly according to claim 2, wherein the opening formed by the mounting plate is substantially larger than the opening formed by the strike plate.

4. A strike plate assembly according to claim 1, wherein the mounting plate forms a second opening for receiving a bolt from a door knob or lock vertically separated from the first opening, and the strike plate forms a second opening for receiving a bolt from a door knob or lock vertically separated from the first opening, and wherein the first opening formed by the strike plate substantially overlaps the first opening formed by the mounting plate and the second opening formed by the strike plate substantially overlaps the second opening formed by the mounting plate.

5. A strike plate assembly according to claim 4, wherein the openings formed by the mounting plate are substantially larger than the corresponding openings formed by the strike plate.

6. A strike plate assembly for mounting on a door frame, wherein the door frame forms a clearance hole for receiving the strike plate assembly, comprising in combination:
a mounting plate for affixing to the door frame in the clearance hole, wherein the mounting plate forms a first opening for receiving a bolt from a door knob or lock and forms two substantially parallel slots;
a first strike plate for affixing to the mounting plate, forming an opening for receiving a bolt from a door knob or lock and forming two substantially parallel slots which are at right angles to the two substantially parallel slots of the mounting plate, wherein each of the parallel slots of strike plate crosses over a corresponding one of the parallel slots of the mounting plate when the first strike plate is properly affixed to the mounting plate;
a pair of bolts, one bolt for fitting through each of the parallel slots of the first strike plate and the corresponding parallel slot of the mounting plate; and
a pair of nuts for securing the pair of bolts, thereby affixing the first strike plate to the mounting plate, wherein the position of the bolts can be adjusted in the parallel slots of the mounting plate and in the parallel slots of the strike plate, whereby the first strike plate can be adjusted both vertically and horizontally with respect to the mounting plate;
wherein the mounting plate forms a second opening for receiving a bolt from a door knob or lock vertically separated from the first opening;
a second strike plate, vertically separated from the first strike plate, forms an opening for receiving a bolt from a door knob or lock, and wherein the opening formed by the first strike plate substantially overlaps the first opening formed by the mounting plate and the opening formed by the second strike plate substantially overlaps the second opening formed by the mounting plate.

7. A strike plate assembly according to claim 6, wherein the openings formed by the mounting plate are substantially larger than the corresponding openings formed by the strike plates.
